(19) United States
(12) Patent Application Publication
(10) Pub. No.: US 2023/0216327 A1
(43) Pub. Date: Jul. 6, 2023

(54) ENERGY MANAGEMENT SYSTEM

(71) Applicant: Faiveley Transport Tours, Saint-Pierre-des-Corps (FR)

(72) Inventors: Philippe Aubin, Chanceaux sur Choisille (FR); Bruno Colas, Joue les Tours (FR)

(21) Appl. No.: 18/113,506

(22) Filed: Feb. 23, 2023

Related U.S. Application Data
(63) Continuation-in-part of application No. 16/342,439, filed on Apr. 16, 2019, now Pat. No. 11,592,489.

(30) Foreign Application Priority Data
Oct. 17, 2016 (FR) 1660056

(51) Int. Cl. H02J 7/00

(52) U.S. Cl. CPC H02J 7/007182; H02J 7/007194; H02J 7/0048; H02J 7/0014

(57) ABSTRACT

An energy management system may include local unit(s) associated with energy storage devices. The local unit(s) may compare operating parameter values of the storage devices with a setpoint. The local unit(s) can generate an output signal representative of a comparison of the operating parameters values with the setpoint value. The system also may include a monitoring unit operably coupled with the local unit(s). The monitoring unit may receive the comparison from the local unit(s) and generate a time-varying, repeating signal that is based on the comparison. This signal has one or more characteristics indicative of the number of the energy storage devices having operating parameter values that are outside of the designated range.

### CROSS-REFERENCE TO RELATED APPLICATIONS

This application is a continuation-in-part of U.S. patent application Ser. No. 16/342,439 (filed 16 Apr. 2019), which claims priority to International Patent Application No. PCT/FR2017/052833 (filed 16 Oct. 2017), which claims priority to French Patent Application No. 1660056 (filed 17 Oct. 2016). The entire disclosures of these applications are incorporated herein by reference.

### BACKGROUND

### Technical Field

The subject matter described herein relates to management of energy storage devices (e.g., batteries, battery cells, battery modules, etc.).

### Discussion of Art

A battery module may be formed by a set of electricity accumulators, battery cells, or battery elements. In general, in a battery module, several battery cells may be connected in parallel forming a block or group of cells. Several blocks of cells may be connected in series to form a column of cell blocks or column of cells. A battery module may comprise several columns of cells connected in parallel.

Electronic circuits may be associated with the battery modules to ensure proper operation of the battery modules. These electronic circuits may monitor the value of the parameters relative to the battery cells. For example, document EP1977263 describes an electronic circuit checking that the voltage of a battery cell does not exceed a voltage threshold. An electronic circuit may be associated with each battery cell of a battery module and may compare the voltage of the cell to a threshold voltage. When a battery cell exceeds the threshold voltage, the charging process of the battery module may be stopped. In such a system, the threshold voltage can be set by the electronic circuit and a single operation may be provided on exceeding the voltage threshold by one of the cells. As a result, the system may not be flexible.

There are more developed electronic circuits which ensure the proper operation of battery modules such as battery management systems, or BMSs. These systems are widely used today and may be used for battery modules employing certain technologies, such as lithium-ion technology. Among other things, battery management systems may monitor certain parameters relative to the battery cells or battery elements, such as the voltage or the temperature, ensuring these parameters remain within predetermined ranges of values (e.g., within acceptable or designated ranges of values).

Thus, the battery management systems may monitor and control the operation of the battery cells by identifying cells in which a value of voltage and/or temperature may present a problem in the operation of the battery module, for example. Furthermore, based on these voltage measurements, battery management systems may seek to make the voltages of the cells uniform. The systems may discharge the cells for which the voltage is too high relative to a threshold value, by for example connecting a discharging resistance in parallel with those cells. This method may be referred to balancing the cells.

A known battery management system architecture may include local electronic blocks. A local electronic block may be associated with one or more blocks of cells, and a general electronic block may be associated with each column of cells and may be connected to the local electronic blocks associated with one or more blocks of cells in the column. In a battery management system having such a structure, each local electronic block may perform voltage and/or temperature measurements of the blocks of cells that are associated with the local electronic block. The measured voltage and temperature values may be sent to the general electronic block associated with the column of cells.

The general electronic block associated with a column of cells thus receives the values of voltage and/or of temperature measured for the blocks of cells of the column of cells and may check the operation of the blocks of cells on the basis of the values that are received. Thus, for example, the general electronic block may identify that a block of cells exceeding a maximum or minimum temperature or voltage value or command a balancing operation in a particular block of cells.

The battery management system may be used flexibly, for example, by modifying the maximum and minimum temperature and voltage values and the management strategies for the cells using the values measured in the cells may be varied. For battery modules in which the blocks of cells comprise very few cells (for example 1 to 3 cells) and which require redundancy in voltage measurements of each block of cells, the battery management systems may be complex systems and may use a high number of specialized integrated circuits. The use of a high number of specialized integrated circuits can be detrimental to the reliability of the system and may lead to a high cost in the implementation of a battery module, especially for battery modules with a high number of battery cells.

It may be desirable to have a system and method that differs from those that are currently available.

### BRIEF DESCRIPTION

In one example, an energy management system is provided and may include one or more local units associated with energy storage devices that can store and discharge electric energy for powering one or more loads. The local unit(s) may compare values of operating parameter(s) of the energy storage devices with at least a first setpoint value. The local unit(s) also can generate an output signal representative of a comparison of the one or more operating parameters with the at least the first setpoint value. The system also may include a monitoring unit operably coupled with the local unit(s). The monitoring unit may receive the comparison of the operating parameter(s) with the first setpoint value from the local unit(s). The comparison can represent a number of the energy storage devices having the values of the operating parameter(s) that are outside of a designated range associated with the first setpoint value. The monitoring unit can generate and output a time-varying, repeating signal that is based on the comparison of the operating parameter(s) with the setpoint value and has one or more characteristics indicative of the number of the energy storage devices having the values of the operating parameter(s) that are outside of the designated range.

In another example, an energy management system is provided that may include one or more local units associated with battery cells that store and discharge voltage. The one or more local units can compare one or more operating parameters of the battery cells with a designated range associated with a setpoint value and generate an output signal representative of a number of the one or more operating parameters that are outside of the designated range. The system also includes a monitoring unit that can receive a comparison between the one or more operating parameters with the designated range from the one or more local units. The monitoring unit can generate and output a time-varying, repeating signal having one or more characteristics that are based on the number of the battery cells having the one or more operating parameters that are outside of the designated range.

In another example, another energy management system may include one or more local units associated with battery cells. These one or more local units may compare one or more operating parameters of the battery cells with a designated range associated with a setpoint value and generate an output signal representative of a number of the one or more operating parameters that are outside of the designated range. The system also may include a monitoring unit that can receive a comparison of the one or more operating parameters with the designated range from the one or more local units. The monitoring unit may generate and output a time-varying, repeating signal having one or more characteristics that are based on the number of the battery cells having the one or more operating parameters that are outside of the designated range. The monitoring unit may test the one or more local units for failure by changing the setpoint value and monitoring for changes in the output signal from the one or more local units.

### BRIEF DESCRIPTION OF THE DRAWINGS

The subject matter may be understood from reading the following description of non-limiting embodiments, with reference to the attached drawings, wherein below:

FIG. 1 illustrates one example of a battery module;

FIG. 2 illustrates one example of a set formed by the battery module shown in FIG. 1, a battery management system, and an interface device;

FIG. 3 illustrates examples of electronic circuits in a local unit;

FIG. 4 illustrates examples of electronic circuits in a monitoring unit;

FIG. 5 illustrates examples of electronic circuits in a local unit according to an embodiment; and

FIG. 6 illustrates examples of electronic circuits in a monitoring unit according to an embodiment.

### DETAILED DESCRIPTION

The subject matter described herein relates to an energy management system that monitors parameters of energy storage devices, such as states of charge, voltages, temperatures, etc., and optionally controls operation of the energy storage devices based on the parameters that are monitored (e.g., charging, load balancing, changing temperatures, etc.). The energy management system may include an interface device, and optionally a battery module that includes the interface device.

The interface device may provide an interface between groups of energy storage devices (e.g., battery cells, fuel cells, capacitors, etc.) and the battery management system. The energy storage devices may be charged with, and store electric energy supplied from one or more power sources (e.g., generators, alternators, regenerative braking, utility grids, flywheels, fuel cells, etc.), and may discharge the electric energy that is stored to power one or more loads. Fuel cells may be energy storage devices in that the energy stored in the materials input into the fuel cells is discharged (e.g., extracted) as energy (e.g., voltage).

A battery module may be formed by a set of energy storage devices, such as electricity accumulators (e.g., battery cells, battery elements, fuel cells, capacitors, etc.). In a battery module, several energy storage devices such as battery cells can be connected in parallel to form a block or group of cells. Several blocks of the cells can be connected in series to form a column of cell blocks or column of cells. A battery module can include several columns of the cells that are connected in parallel.

Electronic circuits may be associated with the battery modules to ensure proper operation of the battery modules. These electronic circuits may monitor values of parameters indicative of operation of the battery cells (e.g., temperature, voltage, or states of charge, etc.).

The battery management system can monitor parameters of the energy storage devices, such as voltages, temperatures, states of charge, etc.) to control the energy storage device and ensure that these parameters remain within one or more predetermined ranges of values. The battery management systems can monitor and control the operation of the energy storage devices by identifying energy storage devices in which a value of voltage, temperature, state of charge, etc. may present a problem in operation of the battery module or a load that is powered by the energy storage devices, such as a traction motor, another type of motor that does not generate tractive effort, an auxiliary load of a vehicle, etc. The battery management systems may control the energy storage devices to balance (e.g., equalize) voltages or states of charge of the energy storage devices, to charge energy storage devices having voltages or states of charge lower than the designated range, to discharge energy storage devices having voltages or states of charge greater than the designated range, to cool energy storage devices that are warmer or hotter than the designated range, to warm energy storage devices that are cooler than the designated range, or the like. On the basis of these monitored values of the energy storage devices, energy management systems can seek to make the values (e.g., voltages) of the energy storage devices uniform or more uniform. For example, the energy management system can discharge the cells for which the voltage is too high relative to a threshold value (e.g., by connecting a discharging resistance or other load in parallel with those cells). This method is generally known under the name of balancing.

The inventive subject matter described herein can provide an interface device for interfacing between an energy management system and groups of energy storage devices of energy or battery module. The interface device can simplify management of the groups of energy storage devices while increasing the reliability of this management.

One example of the inventive subject matter provides an interface device for interfacing between a battery management system and groups of energy storage devices. The interface device may include one or more sets or groups of local units and at least one general unit. The general unit(s) optionally may be referred to as monitoring unit(s). The local and monitoring units may be connected with each other, and with the battery management system (e.g., via wired or wireless connections). Each of the local units can be associated with a group of energy storage devices, such as the energy storage device(s) whose operation, condition, and/or state is or are monitored by the associated local unit.

Each local unit may include a comparison device that compares a parameter of the group of energy storage devices associated with the local unit. This parameter may be associated with a first setpoint value or threshold that can be obtained or received from the monitoring unit. The comparison device may generate an output signal that represents a result of the comparison of the parameter of the energy storage devices with the first setpoint value or threshold. The comparison device may represent hardware circuitry that includes and/or is connected with one or more processors that perform this comparison and generate the output signal. The monitoring unit can receive the output signals from the comparison devices of the local units. The monitoring unit may include an electronic module or device (e.g., hardware circuitry that includes and/or is connected with one or more processors) that can generate or calculate an operating parameter. This operating parameter of the monitoring unit can have a value that depends on, or changes based on the output signals provided by the local units. The value of the operating parameter of the monitoring unit can represent the number of comparison results indicating that the value of the parameter relative to an associated group of cells is greater than the first setpoint value, or representing the number of comparison results indicating that the value of the parameter relative to an associated group of cells is less than the first setpoint value. For example, the value of the operating parameter of the monitoring unit will increase or be larger responsive to more local units determining that the operating parameters of the associated energy storage devices exceed the first setpoint value, and the value of the operating parameter of the monitoring unit will decrease or be smaller responsive to fewer local units determining that the operating parameters of the associated energy storage devices exceed the first setpoint value.

In one example, the electronic module or device of the monitoring unit may include an output circuit, such as an oscillator circuit. The operating parameter of the monitoring unit can be or can include the period of oscillation of the oscillator circuit. The local units may be connected to the electronic module or device of the monitoring unit by means output capacitors. These output capacitors may be connected in parallel with an oscillator capacitor of the electronic module or device of the monitoring unit. Optionally, the output capacitors may be disconnected according to the output signal(s). The comparison of the parameter of a group of energy storage devices with the first setpoint value thus may be carried out locally in the local unit associated with the group of energy storage devices. This can simplify operations carried out in the monitoring unit, while leaving control of the interface device to the monitoring unit.

The local units generate the output signals that represent the results of the comparisons. The set of these output signals may cause the monitoring unit to vary the general value of the operating parameter of the electronic device in the monitoring unit (e.g., the period of oscillation). The value of this operating parameter can represent results of the comparisons made by the local units. In one example, each output signal can include or represent a positive or negative result or value. The positive result or value can indicate that the parameter of the group of energy storage units or devices is greater than the first setpoint value. The negative result or value can indicate that the parameter of the group of energy storage units is not greater than the first setpoint value or alternatively is less than the first setpoint value.

The value of the operating parameter of the electronic module or device of the monitoring unit can vary or change responsive to a change in the number of output signals representing positive results (and therefore the number representing negative results) varies. For example, as more local units report that the parameter of an associated group of one or more energy storage devices is greater than the first setpoint value, the value of the operating parameter of the monitoring unit may increase. As more local units report that the parameter of an associated group of one or more energy storage devices is not greater than the first setpoint value, the value of the operating parameter of the monitoring unit may decrease. Alternatively, as more local units report that the parameter of an associated group of one or more energy storage devices is greater than the first setpoint value, the value of the operating parameter of the monitoring unit may decrease. As more local units report that the parameter of an associated group of one or more energy storage devices is not greater than the first setpoint value, the value of the operating parameter of the monitoring unit may increase.

In one example, if the operating parameter of the monitoring unit is the oscillation period of the oscillator circuit, then the oscillation period (and/or the oscillation frequency) of the oscillator circuit can vary according to the results of comparisons implemented by the local units. This oscillation period can represent the number of local units generating a positive result (or a negative result).

Each local unit can be connected with the monitoring unit (or the oscillator circuit of the monitoring unit) by means of an output capacitor. These output capacitors can be connected in parallel with an oscillator capacitor of the oscillator circuit or disconnected according to the output signal. For example, when a local unit generates an output signal representing a positive result, the output oscillator may be connected in parallel with the oscillator capacitor of the oscillator circuit, thereby varying the oscillation frequency or period of the oscillator circuit. As a result, the number of local units generating a positive result may be deduced according to the value of the oscillation period or oscillation frequency of the oscillator circuit.

Therefore, due to examination of the value of the operating parameter of the electronic module of the monitoring unit, the operating parameter being the oscillation period of the oscillator circuit, the existence of at least one local unit generating an output signal indicating that the value of a parameter relative to an associated group of energy storage devices is greater than or less than the first setpoint value can be determined. Moreover, the number of local units detecting the exceeding of the first setpoint value for associated groups of energy storage devices, or the number of local units detecting the lower magnitude of the first setpoint value for associated groups of energy storage devices, may be deduced by the monitoring unit according to the general value of the operating parameter or oscillation period of the oscillator circuit.

The first setpoint value used by the local units may be provided by the monitoring unit, which can receive the first setpoint value as input. The monitoring unit may send the general value to the battery management system. The general value of the operating parameter of the monitoring unit can be communicated to the exterior of the interface device for a module connected to the interface device, such as the energy management system, to be informed of the general value and be able to use the general value, as described herein.

The energy management system and/or the monitoring unit can successively address different first setpoint values to determine the state or condition of the energy storage devices. For example, by performing scanning or otherwise changing the first setpoint value and examining the output signals from the local units using the different first setpoint values, different operating parameters of the monitoring unit can be determined. It may thus be possible to obtain a histogram of the number of groups of energy storage devices having parameters that exceed or do not exceed the different first setpoint values according to the ranges of the different first setpoint values.

It also may be possible to check that the output signal of a local unit does not remain fixed in one state, which is a sign of a fault in the interface device. For example, if a local unit repeatedly provides the same output signal even when provided with several different first setpoint values, this many indicate that the local unit is not operating correctly or as desired. The interface device may include a test unit that can compare a setpoint signal representing a first setpoint value with a reference value. The test unit can check the first setpoint value, for example by varying the first setpoint value around the reference value. Thus, the test phases of the interface device may be implemented in simplified manner, and the test of the interface device may be improved.

An output capacitor may be placed in or included each local unit and/or the output capacitors can be placed in or included in the monitoring unit. Each local unit may include multiple comparison modules or devices for comparing a parameter of a group of the energy storage devices with different second setpoint values associated with the different comparison modules or devices. The second setpoint values may be provided by the monitoring unit, and, according to the result of the comparison, for generating a local command acting on the local unit. This local command may be used to balance the voltages, states of charge, and/or temperatures of groups of the energy storage devices. It is triggered by the associated unit, by a simple comparison, the moment at which the balancing can be triggered responsive to exceeding of the second setpoint value. The local command can include a second output signal representing the result of the comparison, with an output resistance being connected or not connected to the output of the local unit according to the second output signal. This resistance may be used to discharge or partially discharge the associated group of energy storage devices in the context of the balancing of group voltage of these energy storage devices.

The interface device can generate the output signal according to the result of the comparison of the parameter of a group of energy storage devices with the second setpoint value generated by the second comparison module.

The comparison of the parameter relative to a group of energy storage devices with the second setpoint value may provide redundancy relative to the comparison of the parameter with the first setpoint value. The proper operation of the interface device and the local units can thereby be checked.

The second setpoint value can be used in balancing operations and in testing operations. The value of the second setpoint may be used as a balancing command and temporarily as verification of the results arising from the comparisons of the parameter with values of the first setpoint. The parameter of a group of energy storage devices may be a voltage (e.g., a state of charge) or a temperature, and the setpoint value can be a value of voltage, state of charge, or temperature.

Each local unit can compare at least one additional parameter relative to a group of energy storage devices with at least one additional first setpoint value.

Each local unit may include a first comparison module or device having comparison means (e.g., hardware circuitry that includes and/or is connected with one or more processors, as described herein). The first comparison module or device may include a first input that can receive the parameter from the group of energy storage devices associated with the local unit. The parameter can be indicative of operation of the group of the energy storage devices associated with that local unit, as described herein. The first comparison module or device also may include a second input that can receive a signal representing the first setpoint value from the monitoring unit. The first comparison module or device can generate an output signal indicative of the comparison of the parameter with the first setpoint value. The first comparison module or device may include switching means (e.g., one or more electronically controlled switches) that connect or disconnect the local unit with or from the monitoring unit. The switching means may be controlled to alternate between connecting or disconnecting the local unit from the monitoring unit based on or under command of the output signal.

The monitoring unit can include generating means for generating the signal that represents the first setpoint value. The generating means can include hardware circuitry that includes and/or is connected with one or more processors. The signal representing the first setpoint value can be or include a repeating signal (e.g., an oscillating signal, such as a square-wave signal) having one or more characteristics that represent the first setpoint value (e.g., the amplitude of the signal). Each of the local units can be connected to the generating means by a capacitor. The connections by capacitors between the local units and the monitoring unit can make it possible to implement local and monitoring units at different references of potential. Thus, the electrical voltage withstanding capability of the local units may be limited to a maximum or other upper limit on voltage of the associated group of energy storage devices. The electrical voltage withstanding capability of the monitoring unit may be less than the voltage of the battery module or group formed by the groups of energy storage devices associated with the local units.

The local units may include second comparison modules or device having additional comparison means. The second comparison module or device may have a first input that can receive the parameter from the group of energy storage devices and a second input that can receive a signal representing a value of the second setpoint. The second comparison module or device can generate and an output signal and may include additional switching means connecting or disconnecting an output resistance to an output of the local unit. The switching means can be controlled by the output signal.

The monitoring unit can include the generating means for generating the setpoint signal representing the value of the second setpoint. This signal may be a square-wave signal having a characteristic (e.g., an amplitude) representing the value of the second setpoint. The local units may be connected to or receive the signal by means of a coupling capacitor.

According to another aspect, the inventive subject matter may be directed to a battery management system comprising an interface device in accordance with the inventive subject matter. According to another aspect, the inventive subject matter may be directed to a battery module comprising at least one column of cells comprising several groups of battery cells connected in series, with each group of battery cells comprising several battery cells connected in parallel, and the battery module comprising an interface device in accordance with the inventive subject matter.

According to another aspect, the inventive subject matter may be directed to a set comprising groups of battery cells and a battery management system, the groups of battery cells forming at least one column of cells, the groups of battery cells being connected together in series, each group of battery cells comprising several battery cells connected together in parallel, the set comprising an interface device in accordance with the inventive subject matter disposed between the battery management systems and the groups of battery cells.

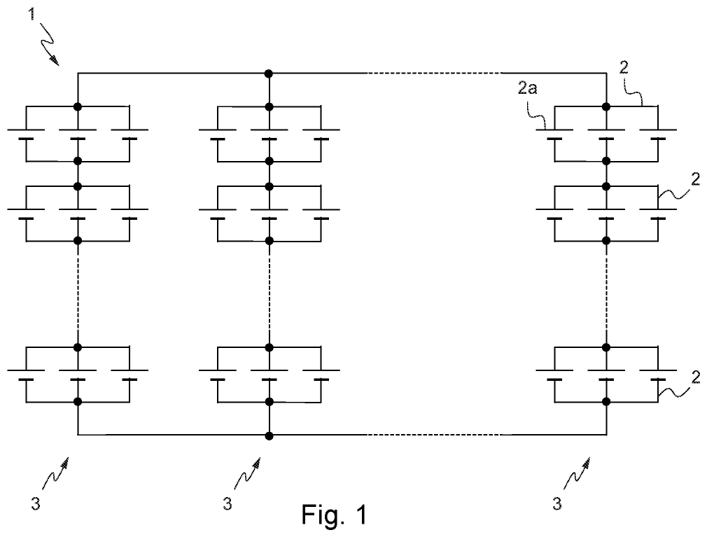

FIG. 1 illustrates one example of an energy storage module or battery module. The battery module may include groups of energy storage devices 2, 3 connected in series and/or in parallel, so as to form a column of groups of energy storage devices or a column of the energy storage devices. Each group of the energy storage devices may include several energy storage devices connected in parallel.

The battery module can include several columns of the energy storage devices connected in parallel. Each group of the energy storage devices may include three energy storage devices 2a connected in parallel. Optionally, the number of energy storage devices per group could be different from three and could even comprise a single energy storage device. In the illustrated example, three groups of energy storage devices are included in each column, and three columns are included in the battery module. Optionally, the number of groups of energy storage devices per column and/or the number of columns per battery module may change.

Different types of energy storage devices may be used in the battery modules. For example, the energy storage devices may be Lithium-ion batteries. The use of this type of battery cell can make it possible to implement battery modules having a reduced volume and weight for a capacity equivalent to a battery module using other types of batteries. These types of battery modules may have various applications and may apply particularly to transport vehicles such as rail transport vehicles, for example such as trains, metros, tramways, trolley-buses, etc., as well as automobiles, trucks, locomotives, aircraft (manned and unmanned), marine vessels, agricultural vehicles, mining vehicles, other off-highway vehicles, etc.

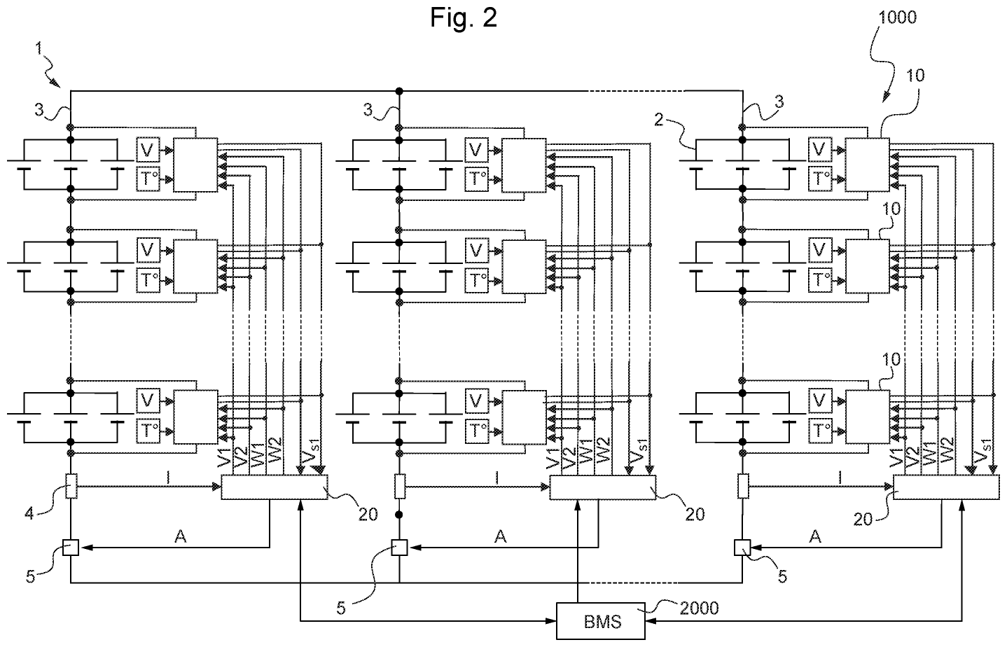

In FIG. 2, an interface device 1000 between an energy management system 2000 and the battery module described with reference to FIG. 1 is illustrated. The interface device may include one or more local units 10 and one or more monitoring units 20. The number and/or arrangement of the local units and monitoring units shown in FIG. 2 is provided as only one example and is not limiting on all embodiments of the inventive subject matter. A set of local units can be formed by the local units associated with groups of energy storage devices connected in series. For example, a local unit may be associated with those energy storage devices connected in series with each other such that the potential or voltage provided by these energy storage devices is summed or combined (e.g., part of the same column of energy storage devices). The local units of a set of local units can be connected to the monitoring unit. The set of local units may be defined as several local units connected to the same monitoring unit.

The monitoring unit may include connection means for connection to the energy management system. The connection means or terminals described herein can include one or more conductive pathways (e.g., wires, conductive traces, cables, etc.) and/or wireless connections (e.g., inductive connections). The interface device may provide an interface or connection between the battery module and the energy management system.

In FIG. 2, three monitoring units are shown with each monitoring unit connected to several local units forming a set of local units connected to the monitoring unit. While three sets of local units connected to three monitoring units are illustrated, optionally more or fewer local units (or a single one) may be connected with a monitoring unit and/or more or fewer monitoring units (or a single one) may be provided. In the illustrated embodiment, each set of local units and the monitoring unit (to which the set of local units is connected) is associated with a column of the energy storage devices 3.

Several sets of local units and the associated monitoring unit may be associated with groups of energy storage devices forming part of a same column of the energy storage devices. A single monitoring unit may be connected to the local units associated with groups of the energy storage devices forming part of the columns of the different storage devices.

A local unit can compare a parameter of an associated group of energy storage devices 2 with a first setpoint value. This parameter can be referred to as an energy storage parameter, a device parameter, or a group parameter. The setpoint value used by the local units can be provided by the monitoring unit to which the local unit(s) is or are connected. Each local unit can generate an output signal Vs1 that represents the result of the comparison of the energy storage parameter with the first setpoint value. The output signal Vs1 can be addressed or otherwise sent to the monitoring unit. The monitoring unit can receive the first setpoint value. For example, the first setpoint value can be provided by the energy management system.

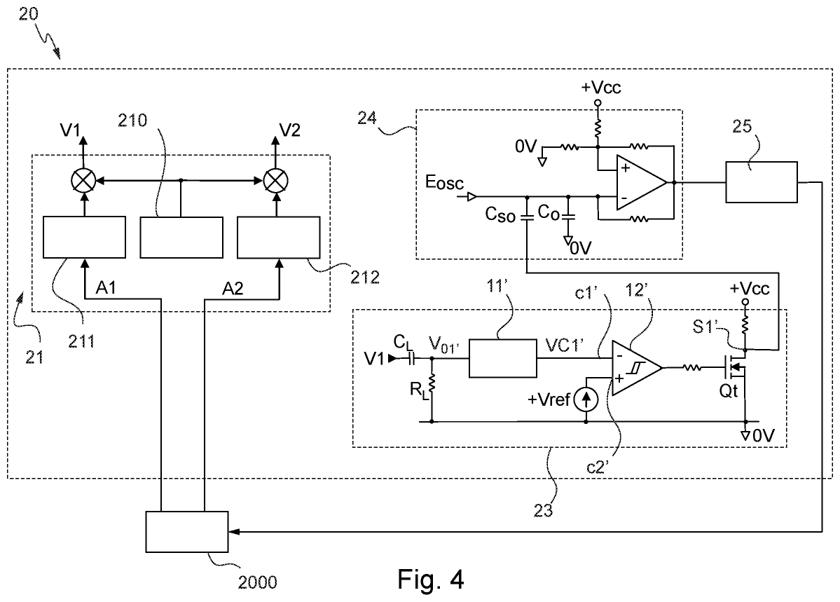

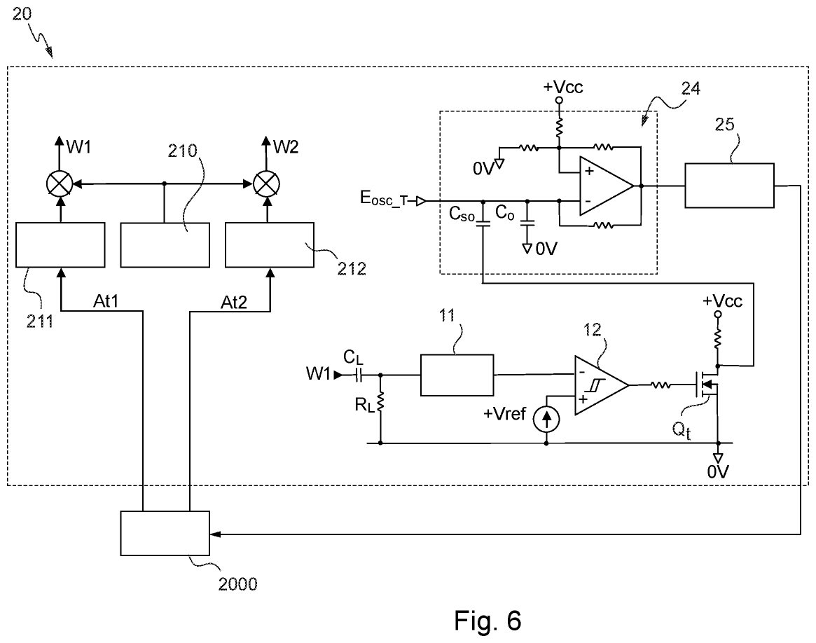

The monitoring unit may include an electronic module 24 (shown in FIGS. 4 and 6) having an operating parameter (which can be referred to as a dependent operating parameter). The dependent operating parameter may have a value that varies, depends, and/or is based on the output signals Vs1 provided by the local units of the set of local units associated with the monitoring unit.

The output signal Vs1 representing the result of the comparison may indicate that the value of the parameter relative to an associated group of energy storage devices is greater than the setpoint value, or that the value of the parameter is less than or no greater than the setpoint value. The general value of the operating parameter of the electronic module may represent the number of comparison results indicating that the values of the parameter (for the different groups of energy storage devices) is greater than the setpoint value and/or may represent the number of comparison results indicating that the values of the parameter (for the different groups of energy storage devices) is less or no greater than the setpoint value.

The output signals Vs1 provided by the local units may act on (e.g., change or dictate) the general value of the operating parameter of the electronic module. For example, the electronic module of the monitoring unit may receive the output signals Vs1 from the local units. The electronic module of the monitoring unit may set or change the general value of the operating parameter for the monitoring unit based on these output signals Vs1 provided by the local units. The monitoring unit may send the general value of the operating parameter from the electronic module of the monitoring unit to the energy management system.

The interface device 1000 may be disposed between the battery module and the energy management system. The energy management system may generate the setpoint value and communicate this setpoint value to the monitoring unit. The monitoring unit may send this setpoint value to the local units of the set of local units associated with that monitoring unit. The energy management system optionally may receive the general value of the operating parameter of the electronic module of the monitoring unit from the interface device.

The energy management system may compute the number of positive results of the comparisons and the number of negative results using this general value. For example, the energy management system may calculate that twenty out of thirty sets of local units indicate that the operating parameters of the energy storage devices associated with the local units exceed the setpoint value and may calculate that ten of the thirty sets of local units indicate that the operating parameters of the energy storage devices associated with those local units do not exceed the setpoint value. The energy management system may use this calculation or these calculations (e.g., the number, percentage, or fraction of the local units having operating parameters that exceed the setpoint value and/or the number, percentage, or fraction of the local units having operating parameters that do not exceed the setpoint value) to deduce or determine whether there are groups of energy storage devices having voltages (e.g., states of charge) and/or temperatures that exceed the setpoint value.

The energy management system may modify the setpoint value to perform scanning of various different setpoint values. The energy management system may thereby obtain general values associated with each of the different setpoint values. For example, with respect to voltages or states of charge of the energy storage devices, the interface device or monitoring unit(s) can set the setpoint value to a first, lower value, communicate this setpoint value to the local units, receive signals from the local units indicating how many of the energy storage devices have voltages or states of charge that exceed the first value, and calculate how many and/or which ones of the energy storage devices have the voltages or states of charge that exceed the first value. The interface device or monitoring unit(s) can change the setpoint value to a second, greater value, communicate this setpoint value to the local units, receive signals from the local units indicating how many of the energy storage devices have voltages or states of charge that exceed the second value, and calculate how many and/or which ones of the energy storage devices have the voltages or states of charge that exceed the second value. The interface device or monitoring unit(s) can change the setpoint value to additional, other values, and repeat this process to identify the different voltages or states of charge of the energy storage devices. Use of many different setpoint values and/or values that are closer together can provide increased precision or granularity in determining the various voltages or states of charge of the energy storage devices, while use of fewer setpoint values and/or values that are farther apart can provide decreased precision or granularity in determining the various voltages or states of charge of the energy storage devices.

As another example, with respect to temperatures of the energy storage devices, the interface device or monitoring unit(s) can set the setpoint value to a first, lower temperature, communicate this setpoint value to the local units, receive signals from the local units indicating how many of the energy storage devices are warmer than the first temperature, and calculate how many and/or which ones of the energy storage devices are warmer than the first temperature. The interface device or monitoring unit(s) can change the setpoint value to a second, warmer temperature, communicate this setpoint value to the local units, receive signals from the local units indicating how many of the energy storage devices are warmer than the second temperature, and calculate how many and/or which ones of the energy storage devices are warmer than the second temperature. The interface device or monitoring unit(s) can change the setpoint value to additional, other temperatures, and repeat this process to identify the different temperatures of the energy storage devices. Use of many different setpoint values and/or values that are closer together can provide increased precision or granularity in determining the various temperatures of the energy storage devices, while use of fewer setpoint values and/or values that are farther apart can provide decreased precision or granularity in determining the various temperatures of the energy storage devices.

With these different values respectively obtained for the setpoint values, the energy management system can obtain a histogram or other data summary representing the number of energy storage devices exceeding or not exceeding the various setpoint values. The energy management system may check that the output signal Vs1 of a local unit does not remain fixed in one state over an extended or designated period of time, which may indicate a fault in the interface device. For example, the energy management system (e.g., the controller or processor(s) of the energy management system) may determine whether, when the setpoint value varies between a lower value and an upper value, the general values representing the number of comparison results comprise at least one value representing a null number of comparison results and another which represents an increased possible number of comparison results. Therefore, the proper operation of the interface device may be ensured. For example, if the signal output from a local unit does not change responsive to the setpoint value being changed between different values, this may indicate a fault or failure with the interface device, the local unit, the monitoring unit, and/or the energy storage devices. One or more responsive actions can be implemented, such as the energy management system or interface device generating an output signal to an output device (e.g., a display, speaker, etc.) to warn or notify an operator, generating the output signal to open switches or contactors to disconnect the energy storage devices from one or more loads or charging devices (e.g., power sources), or the like. This can prevent damage to energy storage devices having faults (e.g., ground connection faults, failed battery cells, etc.) and/or can prevent damage to loads (e.g., where the battery cells may be discharging energy that would damage the loads). As another example, the energy management system or interface device can activate a thermal management system, such as a system that supplies or changes a working fluid in or around the energy storage devices, to cool or heat the energy storage devices. This can be used to condition or precondition the energy storage devices for faster charging or discharging (e.g., to change the temperature of the battery cells to within a threshold range in which the cells charge or discharge faster than at temperatures that are outside of this threshold range).

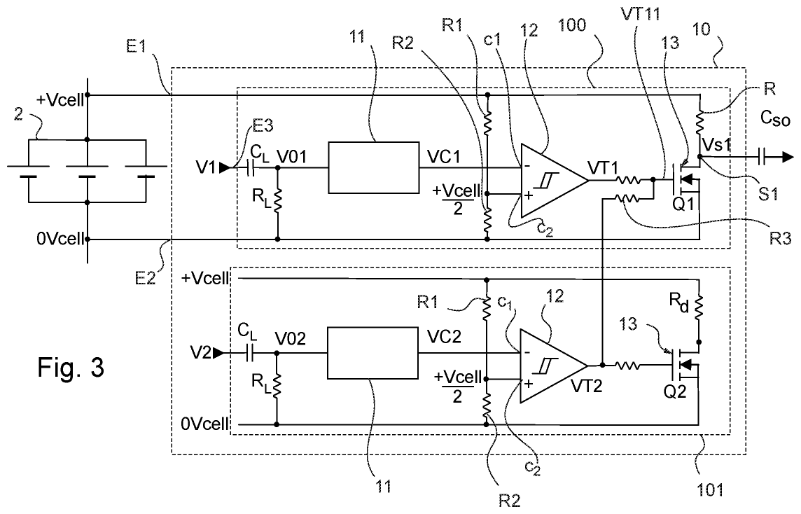

FIG. 3 represents one example of a group of energy storage devices with an associated local unit. The local unit may include a first input E1 and a second input E2, which can be respectively connected to terminals of a group of the energy storage devices. These inputs can represent conductive connections, such as connectors, wires, cables, etc., and/or inductive or wireless connections, through which signals (e.g., voltages, temperature measurements, etc.) may be communicated or obtained. The local unit may receive, via the first input E1 and/or the second input E2, a voltage (Vcell) at the terminals of the group of energy storage devices. The local unit may include a third input E3 via which the local unit can receive a setpoint signal V1, which can include or indicate the setpoint value provided by the monitoring unit. Optionally, fewer (or a single) input may be used, or more than three inputs may be used.

A first coupling capacitor CL may be connected or disposed between the third input and a peak detector module or device 11. The peak detector module or device may represent one or more sensors, processors, or the like. The output VC1 of the peak detector device may be connected to a first input c1 of a comparator device 12. This input also can represent one or more conductive connections, such as connectors, wires, cables, etc., and/or inductive or wireless connections, through which signals (e.g., voltages, temperature measurements, etc.) may be communicated or obtained. The comparator device may represent a device that compares voltages or currents, and outputs a signal indicating which is larger. The comparator device may include analog input terminals and a binary digital output. The comparator may include a high-gain differential amplifier. A coupling resistor RL may be connected between the input of the peak detector device and the second input of the local unit. This second input of the local unit may receive a reference voltage or other signal, such as a zero volt signal (0Vcell in the Figure).

Resistors R1, R2 may be connected in series between the first input and the second input of the local unit to form a voltage divider. The voltage taken between these resistors may be connected to a second input c2 of the comparator device. The inputs described herein can represent one or more conductive connections, such as connectors, wires, cables, etc., and/or inductive or wireless connections.

The resistive values of the resistors R1, R2 of the voltage divider may be identical or within a threshold, non-zero range of each other (e.g., within a designated percentage such as 1%, 3%, 5%, etc., or within manufacturing tolerances of each other). The voltage between the resistors may be half the voltage Vcell at the terminals of the group of energy storage devices (e.g., Vcell/2).

The comparator device may include a comparator with hysteresis. This comparator may generate an output signal VT1 that can represent the result of the comparison between the signals input to the input terminals c1, c2. Switching means 13 (e.g., one or more switches, such as semiconductor switches, contactors, etc.) can be connected to the output of the comparator. These switch(es) can be controlled by the output signal VT1 of the comparator. According to the output signal VT1 from the comparator, the switch(es) can be activated or deactivated (e.g., closed or opened), thereby modifying the output signal Vs1 from the local unit. The output signal Vs1 can be obtained or taken at the output S1 of the local unit. The switch(es) can close to connect the output signal VT1 from the comparator to the output S1 of the local unit. According to the state of operation of the switch(es) (e.g., whether the switch(es) is or are open or closed), the output signal Vs1 may be different. This output signal Vs1 can represent the result of the comparison performed by the comparator. As a result, the state of the switch(es) can indicate the result of the comparison (e.g., that the operating parameter exceeds the setpoint value (whereby the switch(es) close or are closed) or does not exceed the setpoint value (whereby the switch(es) open or are opened). Alternatively, the switch(es) open or be opened while the operating parameter exceeds the setpoint value or close or be closed while the operating parameter does not exceed the setpoint value.

In one example, the switching means can include a field effect transistor Q1 or metal oxide semiconductor field effect transistor (MOSFET), or another type of switch. The MOSFET can be an N-type MOSFET.

An output capacitor Cso may be connected to the output S1 of the local unit by a first terminal and a second terminal can be connected to the monitoring unit. Optionally, the output capacitance or capacitor Cso can be included in the monitoring unit 20. The comparator and/or the switching means can be other types than those described in connection with FIG. 3. Different types of transistors may be used that are suitable for operating with the comparator or a comparator that does not have hysteresis.

A resistor R can be connected between a drain of the switch Q1 and a positive terminal Vcell of the group of energy storage devices 3. This resistor may be referred to as the switch resistor.

The electronic circuit described above can a first comparison module or device 100. The local unit also may include a second comparison module or device 101 that is similar or identical to the first comparison module or device. Although identical components are repeated in different modules or devices, the component may have the same numerical references herein.

The second comparison module can receive the voltage at the terminals of the group of energy storage devices 2 as well as a second setpoint signal V2 provided by the monitoring unit as input to the second comparison module.

The local unit may include a link resistor R3 that links or connects the output of the comparator 12 of the second comparison module to a gate of the switch Q1 of the first comparison module. The operating mode of the switch Q1 also may depend on the output from the comparator of the second comparison module.

FIG. 4 represents an example of electronic circuits in the monitoring unit. The monitoring unit 20 can generate a first setpoint signal V1 and/or a second setpoint signal V2 as output. The first setpoint signal can represent the first setpoint value while the second setpoint signal can represent the second setpoint value. The monitoring unit can include generation means 21 for generating the setpoint signals V1, V2 (respectively representing the first and second setpoint values). The generation means may include a square-wave signal generation module 210 and amplitude value generation modules 211, 212. These modules can represent pulse modules or generators, or oscillators, and can be individually or collectively referred to as generator devices. The square-wave signal generation module may cooperate with the amplitude value generation modules to generate the setpoint signals V1, V2. The setpoint signals V1, V2 may be square-wave signals or non-square wave, oscillating signals having amplitudes that represent the first and second setpoint values, respectively. The generation means may generate the first signal V1 representing the first setpoint value A1 and the second signal V2 representing the second setpoint value A2. The monitoring unit may include connection means (e.g., one or more conductive contacts or terminals, or wireless connections) through which the monitoring unit communicates with the energy management system. The first and second setpoint values A1, A2 may be received from the energy management system via these connections. The monitoring unit may include a comparison module 23 similar or identical to the first and second comparison modules 100, 101 of the local unit.

In the comparison module 23, the second input c2′ of the comparator 12′ may be a reference value instead of being a division of the voltage at the terminals of the group of energy storage devices.

The comparison module 23 may check the first setpoint signal V1 generated by the generation means. This comparison module can test operations of the interface device, as described herein.

The monitoring unit also may include an electronic module 24, such as an oscillator circuit or other circuit that generates a time-varying signal. The time-varying signal may be a repeating signal (e.g., a time-varying or oscillating signal that repeats itself, such as its amplitude and/or frequency through or over multiple cycles) or a non-repeating signal (e.g., a signal that may vary with respect to time, but that does not repeat its amplitude and/or frequency through or over multiple cycles). The electronic module 24 can be referred to as an output circuit. The output circuit can include an oscillator capacitor CO connected between an input EOSC of the oscillator circuit and a voltage reference (e.g., zero volts or another value).

An output S1′ from the comparison module 23 may be connected or output to the input Eosc of the oscillator circuit. An output capacitor Cos may connect the comparison module 23 with the oscillator circuit.

The monitoring unit may include a measuring module or device 25 that can measure the period and/or frequency of signals output by the output circuit. The measuring device may determine or calculate the number of groups of energy storage devices having voltages and/or temperatures greater than the setpoint value (or not greater than the setpoint value) based on the period or the frequency of the signals output by the output circuit. The measuring module can send a signal indicating this number of energy storage devices to the energy management system.

Based on the output signal from the comparator of the first comparison module of the local unit, an output capacitor Cso may be connected in parallel with the oscillator capacitor CO. The oscillation frequency of the output circuit may be modified responsive to the output capacitor Cso being connected in parallel with the oscillator capacitor CO.

The circuits described above in connection with FIGS. 3 and 4 can be used to monitor the voltage at terminals of the groups of energy storage devices (e.g., battery terminals). Each group of the energy storage devices can be associated with a local unit to detect situations in which at least one group of the energy storage devices has an operating parameter (e.g., voltage and/or temperature) that exceeds (or does not exceed) a certain value (e.g., the setpoint value established by the monitoring unit).

The generator device 21 may generate a square-wave setpoint signal V1 or other time-varying signal having an amplitude A1 that is set by an amplitude control module 211 (e.g., a phase and/or amplitude controller). The amplitude A1 may be received from the energy management system by the monitoring unit. The setpoint signal V1 may have an amplitude A1 that represents the first setpoint value. The setpoint signal V1 may be communicated to the third input of each or one or more of the local units of the set of local units. This setpoint signal V1 may have a peak or upper amplitude corresponding to the first setpoint value V1.

The coupling circuit formed by the coupling capacitor CL and the coupling resistor RL can transform the setpoint signal V1 into an output signal (e.g., a square-wave or other time-varying signal) to center this output signal relative to the reference value of the group of energy storage devices. A modified setpoint signal V01 can be generated relative to the reference voltage value of the group of energy storage devices.

The peak detector module may be a positive peak detector module that generates a voltage or other signal as an output VC1. This output can represent or indicate the amplitude A1 and the first setpoint value. The voltage value VC1 can be supplied to the first input c1 of the comparator 12. This comparator may generate a binary signal VT1 as an output. The state of the signal VT1 can depend, or change based on the comparison made by the comparator 12. As one example, if the voltage value Vcell at the terminals of the group of energy storage devices 2 is greater than twice the amplitude value A1 (or is greater than A1), then the output of the comparator VT1 may be in the high state and the switch Q1 may be saturated. In contrast, if the voltage value Vcell at the terminals of the group of energy storage devices 2 is less than twice the amplitude value A1 (or is not greater than A1), then the output of the comparator VT1 may be in the low state and the switch Q1 may be off (e.g., not saturated).

The output capacitor CSO may be at the output of the local unit in parallel with the oscillation capacitance CO disposed at the input EOSC of the circuit 24 of the monitoring unit while the switch Q1 of the local unit is saturated (e.g., the switch is closed). As a result, while the local unit generates an output signal Vs1 such that the switch Q1 is saturated or closed, the output capacitor CSO may be connected in parallel to the capacitance CO, and the operating period of the output circuit 24 may be proportional to the capacitance value of the capacitor CO, and may be calculated by the formula or relationship:

T_{osc}=K·(Cₒ+Cₛₒ)

where K is a constant having a constant or operator-defined value, Co represents the capacitance of the capacitor CO, and Cso represents the capacitance of the capacitor Cso of the local unit. The capacitances of the output capacitor and of the oscillation capacitor may be identical or within a manufacturing tolerance of each other. Calculation of the operating period Tosc may be carried out by the measuring module 25. While the switches Q1 of a number N of local units are closed or saturated, N output capacitors Cso may be connected in parallel to the capacitor CO of the output circuit. As a result, the oscillation period Tosc may be calculated by the formula Tosc=K·(N+1)·Co. If the switch Q1 is off or open, the output capacitor of the local unit may not be connected in parallel with the capacitance Co of the output circuit of the monitoring unit, and the oscillation period Tosc of the output circuit may not be modified or change, and may be calculated by the formula Tosc=K·Co.

The measuring module 25 may deduce, based on the determined value of oscillation period Tosc, the number N of groups of energy storage devices of which the voltage (or temperature is greater than twice the amplitude A1 (or greater than the amplitude A1) using:

$$N = \frac{T}{K \cdot {C}_{o}} - 1$$

The generation means of the monitoring unit may include a second amplitude generation module 212 that cooperates with the signal generator 210 to generate a second square-wave setpoint signal (or other time-varying signal) V2 having an amplitude A2 (which can represent the second setpoint value). The setpoint signal V2 of amplitude A2 can be supplied to the second comparison module of each local unit (shown in FIG. 3). The setpoint signal V2 may have a peak amplitude corresponding to the second setpoint value A2.

As in the case of the first comparison module, the coupling capacitor CL and the coupling resistor RL may bring the amplitude value A2 to a reference value of the group of energy storage devices 2 (e.g., 0Vcell). The coupling circuit may generate and supply a signal V02 to the peak detector 11 which, in turn, generates a voltage VC2 that is supplied to a first input c1 of the comparator 12. Operation of the second comparison module 101 may be similar or identical to operation of the first comparison module 100. The comparator 12 may implement the comparison between the voltage VC2 generated according to the signal V2 (with an amplitude representing the second setpoint value A2) with half the voltage between the terminals of the group of energy storage devices (e.g., Vcell/2).

While the voltage at the terminals of the group of energy storage devices 2 is greater than twice the amplitude A2 of the signal V02 (or greater than the amplitude A2), the switch Q2 at the output from the comparator 12 may be saturated or closed, thereby linking a load resistor Rd in parallel with the group of energy storage devices.

The resistance value of the resistor R at the output from the first comparison module 100 may be different from the resistance value of the load resistor Rd of the second comparison module 101. While a load balancing operation is implemented (to even out the states of charge of the energy storage devices) and the load resistor Rd is connected to the group of energy storage devices 2, the value of the load resistor Rd may discharge the group of energy storage devices 2 while the value of the resistor R is configured for the operation of the output circuit 24.

The amplitude A2 may represent a second setpoint value that is equal to half an upper or maximum voltage Vmax on the basis of which a balancing operation can be implemented on the group of energy storage devices (Vmax/2=A2). For the groups of energy storage devices having a voltage at terminals greater than twice the value of the amplitude A2 (or greater than the amplitude A2), e.g., greater than the upper voltage Vmax, the switches Q2 may be saturated with the load resistor Rd connected in parallel to the group of energy storage devices. For example, responsive to the group of energy storage devices exceeding the upper voltage Vmax, an operation of load balancing is implemented on the group of energy storage devices to discharge or reduce the state of charge of one or more of the energy storage devices to be equal or closer to that of other energy storage devices.

Each of the local units may compare a parameter relative to a group of energy storage devices (e.g., the voltage at the terminals of the group of energy storage devices) to a second setpoint value (e.g., the upper value Vmax), and, according to the result of the comparison made by the comparator 12, to generate a local command acting on the local unit.

The local command may be a balancing command that includes a second output signal VT2. This signal can represent the result of the comparison, where the load resistor Rd may be connected or not connected to the output of the local unit according to the second output signal VT2.

The second output signal may represent the result of the comparison VT2, with the output from the comparator 12 of the second comparison module being a binary signal able to present a high level or a low level. The second output signal VT2 may have the high level while the voltage Vcell at the terminals of the group of energy storage devices is greater than the upper voltage Vmax and may have the low level while the voltage Vcell at the terminals of the group of energy storage devices does not exceed than the upper voltage Vmax.

By virtue of the structure of the interface device, a balancing operation may be implemented on the groups of energy storage devices having a voltage or state of charge that is greater than the upper value Vmax (where the upper value Vmax can be provided by the monitoring unit), without however having to know either the voltage or state of charge of the different groups of energy storage devices, nor having to identify the groups of energy storage devices exceeding the upper voltage and therefore requiring the balancing operation.

The local unit may generate the output signal Vs1 according to the result of the comparison of the parameter relative to a group of energy storage devices such as the voltage at the terminals of the group of energy storage devices, with the second setpoint value A2. The control signal VT11 of the switch Q1 may be generated by the second comparison module 101 instead of being generated by the first comparison module 100.

For this operation, the generator device 21 of the monitoring unit may generate the setpoint signal V2 with an amplitude A2 representing the first setpoint value, with the setpoint signal V2 being supplied to the second comparison module.

The oscillation period Tosc may be measured by the measuring device 25 in the monitoring unit. The number of groups of energy storage devices exceeding the first setpoint value may be determined according to the oscillation period Tosc.

The energy management system may receive this number of groups of energy storage devices and may thus by comparison of this obtained number with the number obtained when the first comparison module 100 is used for this same operation, check that the first comparison modules 100 are operating correctly. It may therefore be avoided that a battery module is put at risk by improper functioning of a comparison module 100 due, for example, to a failure of an electronic component.

The operation implemented by the second comparison module 101 described above may constitute redundancy in the measurement of the voltage carried out by the first comparison module 100. Thus, the second comparison module 101 may be used to implement the balancing operations and redundant measurements.

The generation of the second signal V2 of amplitude A2 representing the first setpoint value by the monitoring unit may be implemented periodically to perform regular test operations of the functioning of the first comparison module. While the second comparison module is used as a redundant circuit to measure the voltage Vcell at the terminals of the group of energy storage devices, the monitoring unit (e.g., the generator device) may generate the first setpoint signal V1 at a high value such that the comparator of the first comparison module may not generate an output signal VT1 at high level. As a result, the switch Q1 may be off or open, leaving the second comparison module the possibility of being placed into a saturation mode. In a similar way, in normal operation of the local units, while the voltage is measured by the first comparison module 100, the second setpoint signal V2 may be generated at a high value such that the comparator of the second comparison module 101 may not saturate the switch Q1.

The comparison of a number of energy storage devices exceeding a voltage value, or not exceeding the voltage value, obtained using the first comparison module 100 and the first setpoint signal V1, with the number obtained using the second comparison module 101 and the second setpoint signal V2, may make it possible to detect anomalies in one of the comparison modules 100, 101.

The comparison module 23 of the monitoring unit may represent a test unit configured to compare a voltage value VC1′ at the input of the comparator 12′ with a reference value Vref supplied to the second input c2′ of the comparator 12′. The voltage value VC1′ supplied to the first input c1′ of the comparator 12′ may be generated by the peak detector 11′ from a signal V01′ input to the peak detector 11′. This signal V01′ may be generated from the first setpoint signal V1 generated by the generator device. As for the comparison modules 100, 101 described with reference to FIG. 3, a coupling capacitor CL and an input resistor RL may transform the setpoint signal V1 relative to a local reference value, such as zero volts.

In the test operations, the value V1 of the amplitude A1 of the setpoint signal may be modified relative to the version Vref to verify that the comparator 12′ generates an output signal at different states. While the signal output from the comparator 12′ is at a high level, the switch Qt may be saturated or closed, and an additional capacitor COs may be connected in parallel with the oscillator capacitor Co of the output circuit.

The measuring device may measure measures an oscillation period Tosc which depends on the result of the comparator 12′ and the number of groups of energy storage devices having operating parameters that exceed the first setpoint value A1. As a result, the proper operation of the interface device may be ensured simply and without addition of complementary components.

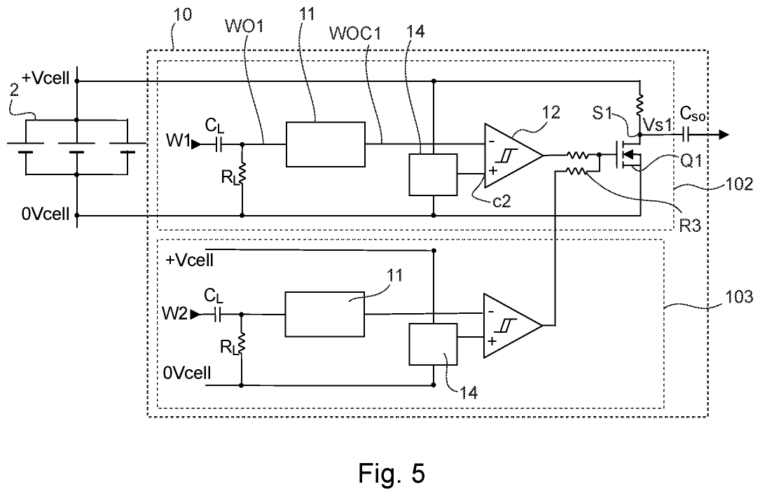

FIG. 5 represents one example of electronic circuits in a local unit provided for the measurement of the temperature of a group of energy storage devices. Thus, the parameter of the group of energy storage devices may be the temperature of the group of the energy storage devices. The local unit may include a first temperature comparison module 102 and a second temperature comparison module 103. The temperature comparison modules may be similar or identical to the voltage comparison modules.

Each of the temperature comparison modules may include a temperature probe or sensor 14 disposed near the group of energy storage devices. The temperature sensor can measure the temperature of the group of the energy storage devices or of individual energy storage devices. The voltage representing the temperature measured by the temperature sensor may be supplied to the second input c2 of the comparator 12. A signal WOC1 may be supplied to the first input c1 of the comparator 12. This signal WOC1 may be generated by a peak detector module 11 which receives (as input) a square-wave setpoint signal or other time-varying signal W1 generated by the monitoring unit, such as by a square-wave signal generator 210 (shown in FIG. 6). The generator module 210, relative to the temperature, may be different from the signal generator module relative to the voltage. Optionally, a single square-wave signal or other type of signal that is time-varying but not square-wave could be used in other embodiments.

The second temperature comparison module may be a test unit for performing redundant measurements in similar manner to those described for the redundant measurements of the voltage at the terminals of the group of energy storage devices made by the second comparison module. In the case of temperature, the output of the comparator of the second temperature comparison module may be connected to the switch Q1 (e.g., to the gate of the switch Q1 by a resistor R3), thereby being able to control the switch Q1 such that the switch Q1 is in saturated mode (e.g., closed) or off mode (e.g., open).

FIG. 6 represents one example of electronic circuits of the monitoring unit concerning the measurement of temperature. The structure of these electronic circuits may be identical or similar to those represented in FIG. 4. The monitoring unit may include a third amplitude generation module or generation device 211 that cooperates with the signal generator 210 to generate the third setpoint signal W1. The monitoring unit may include a fourth amplitude module 212 that cooperates with the signal generator 210 to generate a fourth square-wave or other time-varying setpoint signal W2.

The third and fourth amplitude generation modules or devices 211, 212 may be similar to the first and second generation modules but may be distinct or different components.

The third setpoint signal W1 and the fourth setpoint signal W2 may be sent to the local units of the set of local units associated with the monitoring unit. The monitoring unit may include an additional comparison module similar to the comparison module 23 concerning the voltage measurement. The additional comparison module may be provided to verify the setpoint signal W1 (representing the temperature value) that can be generated by the generator device.

The operation of the set of electronic circuits that determine the temperature (shown in FIGS. 4 and 6) may be similar or identical to operation of the set of circuits measuring the voltage.

Each local unit may measure the voltage and/or the temperature of the groups of the energy storage devices associated with that local unit. As a result, each local unit may include comparison means for comparing a parameter (for example the voltage) relative to a group of energy storage devices with a setpoint value, and comparison means for comparing an additional parameter (for example the temperature) relative to a group of energy storage devices with an additional setpoint value. Stated differently, both the voltages (or states of charge) and temperatures of the energy storage devices may be measured by the energy management system. The parameter of a group of energy storage devices may be the voltage Vcell at the terminals of the group of energy storage devices, and the additional parameter may be the temperature of the group of energy storage devices.

Optionally, the local unit can include either comparison means for comparing the voltage with a setpoint voltage value, or comparison means for comparing a temperature to a setpoint temperature value.

The local units of the interface device may be identical to each other. Optionally, the local units in a set of local units may be identical to each other, but the local units of different sets may be different from each other. Or local units within a set of local units can be different from each other. For example, a first group of local units may include electronic cells for the measurement of the voltage and of the temperature and a second group of local units within the same set may include the electronic circuits for the measurement of the voltage (but not the temperature).

According to another example, a first group of local units may include test circuits and a second group of local units may not include any test circuits. In one example, all the monitoring units may be identical and, alternatively, two or more of the monitoring units may be different (e.g., some may include a test unit while others do not include any test unit).

Returning to the description of FIG. 2, the interface device may include a means for measuring the current disposed in series with groups of energy storage devices. A measurement shunt or resistor 4 of a low or lower value than one or more (or all) other resistors in the circuit(s) may be disposed in each column of energy storage devices 3.

The monitoring unit may include means for measuring the voltage at the terminals of the measurement shunt. Thus, it may be possible to determine whether the current for charging and discharging the column of energy storage devices is exceeding a maximum value or other upper limit/threshold. The monitoring unit may include one or more comparators for comparing the voltage at the terminals of the measurement shunt at a first threshold value and a second threshold voltage value. The first threshold value may represent a maximum or upper limit on the charging current. The second threshold value may represent a maximum or upper limit on the discharging current.

While the charging or discharging current exceeds the charging threshold or the discharging threshold, respectively, the monitoring unit may generate a signal indicative of the presence of a fault in the group of energy storage devices 2 of the column 3 of energy storage devices.

The interface device may include an elimination device 5 for column 3 of energy storage devices. The elimination device may be connected in series with the groups of energy storage devices of each column (or at least one column). The elimination device may be provided to disconnect a column from the rest of the columns of the battery module. For example, this elimination device may be a fuse, switch, or the like. The elimination device for a column may be actuated by the monitoring unit. Therefore, the monitoring unit may include means for generating a command A that activates the elimination device responsive to detection of an anomaly concerning the group of energy storage devices of the column. For example, responsive to determining that a voltage, temperature, charging current, and/or discharging current of a group of energy storage devices is outside of an authorized range, the monitoring unit can control the elimination device to disconnect the group of energy storage devices from the other energy storage devices, from loads, and/or from power sources that charge the energy storage devices. This can allow the battery module to not require maintenance and remains available even though the battery module loses part of its capacity.

The number of columns that can be eliminated during the estimated life of the battery module may be considered in the dimensioning of the battery module to ensure at least a minimum or other lower requirement on the desired capacity for the entire life of the battery module.

By virtue of the structure of the interface device performing the operations locally, the transmission of a high number of signals of the monitoring unit may be avoided, and the cabling of such an interface device may be simple and lessened. Furthermore, the noise between the lines transporting the signals between the local units and the monitoring unit may be avoided or reduced.

The energy management system and/or monitoring unit may have a local data collection system deployed that may use machine learning to enable derivation-based learning outcomes. The monitoring unit may learn from and make decisions on a set of data (e.g., previously measured voltages, temperatures, currents, etc.), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the energy management system may include a policy engine that may apply one or more policies. These policies may be based at least in part on characteristics of a given item of equipment or environment. With respect to control policies, a neural network can receive input of a number of environmental and task-related parameters. These parameters may include one or more of the operational parameters described above. The neural network can be trained to generate an output based on these inputs, with the output representing a setpoint value or a responsive action to implement. During operation of one embodiment, a determination can occur by processing the inputs through the parameters of the neural network to generate a value at the output node designating that action or new setpoint value as the desired action. This action may translate into a signal that causes the monitoring unit to change the setpoint value or the energy management system to implement one or more of the actions described above. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The energy management system or monitoring unit can use this artificial intelligence or machine learning to receive input (e.g., operational parameters, prior setpoint values, etc.), use a model that associates different values of this input with different responsive actions or setpoint values to select a responsive action to implement or a new setpoint value, and then provide an output (e.g., the responsive action that is selected or the new setpoint value that is determined using the model). The energy management system or monitoring unit may receive additional input of the impact of the responsive action or new setpoint value, such as analysis of operation of the energy storage devices, operator input, or the like, that indicates whether the machine-selected responsive action or setpoint value provided a desirable outcome or not. Based on this additional input, the energy management system or monitoring unit can change the model, such as by changing which operating mode would be selected when a similar or identical operational parameter is received the next time or iteration. The energy management system or monitoring unit can then use the changed or updated model again to select a responsive action or new setpoint value, receive feedback on the selected action or value, change or update the model again, etc., in additional iterations to repeatedly improve or change the model using artificial intelligence or machine learning.

In one example, an energy management system is provided and may include one or more local units associated with energy storage devices that can store and discharge electric energy for powering one or more loads. The local unit(s) may compare values of operating parameter(s) of the energy storage devices with at least a first setpoint value. The local unit(s) also can generate an output signal representative of a comparison of the one or more operating parameters with the at least the first setpoint value. The system also may include a monitoring unit operably coupled with the local unit(s). The monitoring unit may receive the comparison of the operating parameter(s) with the first setpoint value from the local unit(s). The comparison can represent a number of the energy storage devices having the values of the operating parameter(s) that are outside of a designated range associated with the first setpoint value. The monitoring unit can generate and output a time-varying, repeating signal that is based on the comparison of the operating parameter(s) with the setpoint value and has one or more characteristics indicative of the number of the energy storage devices having the values of the operating parameter(s) that are outside of the designated range.

The one or more local units may include a first local unit that can compare voltages of the energy storage devices with one or more of an upper voltage threshold or a lower voltage threshold as the at least the first setpoint value. The monitoring unit may load balance one or more of the energy storage devices by charging or discharging the one or more of the energy storage devices based on the time-varying, repeating signal.

The one or more local units may include a first local unit that can compare temperatures of the energy storage devices with one or more of an upper temperature threshold or a lower temperature threshold as the at least the first setpoint value. The monitoring unit may change the temperatures of one or more of the energy storage devices based on the time-varying, repeating signal.

The monitoring unit may generate and output the time-varying, repeating signal with the one or more characteristics that include an amplitude of the time-varying, repeating signal. The monitoring unit can generate and output the time-varying, repeating signal with the one or more characteristics that include a frequency of the time-varying, repeating signal. The monitoring unit may include an oscillator circuit that can generate and output the time-varying, repeating signal as an oscillating signal.

In another example, an energy management system is provided that may include one or more local units associated with battery cells that store and discharge voltage. The one or more local units can compare one or more operating parameters of the battery cells with a designated range associated with a setpoint value and generate an output signal representative of a number of the one or more operating parameters that are outside of the designated range. The system also includes a monitoring unit that can receive a comparison between the one or more operating parameters with the designated range from the one or more local units. The monitoring unit can generate and output a time-varying, repeating signal having one or more characteristics that are based on the number of the battery cells having the one or more operating parameters that are outside of the designated range.

The one or more local units can compare voltages of the battery cells with the designated range. The monitoring unit may change a state of charge of one or more of the battery cells based on the one or more characteristics of the time-varying, repeating signal. The one or more local units can compare temperatures of the battery cells with the designated range. The monitoring unit may change the temperatures of one or more of the battery cells based on the one or more characteristics of the time-varying, repeating signal.

The monitoring unit can generate and output the time-varying, repeating signal with the one or more characteristics that include an amplitude of the time-varying, repeating signal. The monitoring unit may generate and output the time-varying, repeating signal with the one or more characteristics that include a frequency of the time-varying, repeating signal. The monitoring unit may include an oscillator circuit that can generate and output the time-varying, repeating signal as an oscillating signal.

In another example, another energy management system may include one or more local units associated with battery cells. These one or more local units may compare one or more operating parameters of the battery cells with a designated range associated with a setpoint value and generate an output signal representative of a number of the one or more operating parameters that are outside of the designated range. The system also may include a monitoring unit that can receive a comparison of the one or more operating parameters with the designated range from the one or more local units. The monitoring unit may generate and output a time-varying, repeating signal having one or more characteristics that are based on the number of the battery cells having the one or more operating parameters that are outside of the designated range. The monitoring unit may test the one or more local units for failure by changing the setpoint value and monitoring for changes in the output signal from the one or more local units.

The monitoring unit may generate and output the time-varying, repeating signal with the one or more characteristics that include an amplitude and/or frequency of the time-varying, repeating signal. The monitoring unit may include an oscillator circuit that can generate and output the time-varying, repeating signal as an oscillating signal.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C. The terms “at least one of” or “one or more of” a subject can include a singular one of the subject or multiple ones of the subject following the respective term.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. An energy management system, comprising:
one or more local units associated with energy storage devices configured to store and discharge electric energy for powering one or more loads, the one or more local units configured to compare values of one or more operating parameters of the energy storage devices with at least a first setpoint value and to generate an output signal representative of a comparison of the one or more operating parameters with the at least the first setpoint value; and
a monitoring unit operably coupled with the one or more local units, the monitoring unit configured to receive the comparison of the one or more operating parameters with the first setpoint value from the one or more local units, the comparison representing a number of the energy storage devices having the values of the one or more operating parameters that are outside of a designated range associated with the at least the first setpoint value,
the monitoring unit configured to generate and output a time-varying, repeating signal that is based on the comparison of the one or more operating parameters with the first setpoint value and that has one or more characteristics indicative of the number of the energy storage devices having the values of the one or more operating parameters that are outside of the designated range.

2. The energy management system of claim 1, wherein the one or more local units include a first local unit configured to compare voltages of the energy storage devices with one or more of an upper voltage threshold or a lower voltage threshold as the at least the first setpoint value.

3. The energy management system of claim 2, wherein the monitoring unit is configured to load balance one or more of the energy storage devices by charging or discharging the one or more of the energy storage devices based on the time-varying, repeating signal.

4. The energy management system of claim 1, wherein the one or more local units include a first local unit configured to compare temperatures of the energy storage devices with one or more of an upper temperature threshold or a lower temperature threshold as the at least the first setpoint value.

5. The energy management system of claim 4, wherein the monitoring unit is configured to change the temperatures of one or more of the energy storage devices based on the time-varying, repeating signal.

6. The energy management system of claim 1, wherein the monitoring unit is configured to generate and output the time-varying, repeating signal with the one or more characteristics that include an amplitude of the time-varying, repeating signal.

7. The energy management system of claim 1, wherein the monitoring unit is configured to generate and output the time-varying, repeating signal with the one or more characteristics that include a frequency of the time-varying, repeating signal.

8. The energy management system of claim 1, wherein the monitoring unit includes an oscillator circuit configured to generate and output the time-varying, repeating signal as an oscillating signal.

9. An energy management system, comprising:
one or more local units associated with battery cells configured to store and discharge voltage, the one or more local units configured to compare one or more operating parameters of the battery cells with a designated range associated with a setpoint value and to generate an output signal representative of a number of the one or more operating parameters that are outside of the designated range; and
a monitoring unit configured to receive a comparison between the one or more operating parameters with the designated range from the one or more local units, the monitoring unit configured to generate and output a time-varying, repeating signal having one or more characteristics that are based on the number of the battery cells having the one or more operating parameters that are outside of the designated range.

10. The energy management system of claim 9, wherein the one or more local units are configured to compare voltages of the battery cells with the designated range.

11. The energy management system of claim 10, wherein the monitoring unit is configured to change a state of charge of one or more of the battery cells based on the one or more characteristics of the time-varying, repeating signal.

12. The energy management system of claim 9, wherein the one or more local units are configured to compare temperatures of the battery cells with the designated range.

13. The energy management system of claim 12, wherein the monitoring unit is configured to change the temperatures of one or more of the battery cells based on the one or more characteristics of the time-varying, repeating signal.

14. The energy management system of claim 9, wherein the monitoring unit is configured to generate and output the time-varying, repeating signal with the one or more characteristics that include an amplitude of the time-varying, repeating signal.

15. The energy management system of claim 9, wherein the monitoring unit is configured to generate and output the time-varying, repeating signal with the one or more characteristics that include a frequency of the time-varying, repeating signal.

16. The energy management system of claim 9, wherein the monitoring unit includes an oscillator circuit configured to generate and output the time-varying, repeating signal as an oscillating signal.

17. An energy management system, comprising:
one or more local units associated with battery cells, the one or more local units configured to compare one or more operating parameters of the battery cells with a designated range associated with a setpoint value and to generate an output signal representative of a number of the one or more operating parameters that are outside of the designated range; and
a monitoring unit configured to receive a comparison of the one or more operating parameters with the designated range from the one or more local units, the monitoring unit configured to generate and output a time-varying, repeating signal having one or more characteristics that are based on the number of the battery cells having the one or more operating parameters that are outside of the designated range,
the monitoring unit configured to test the one or more local units for failure by changing the setpoint value and monitoring for changes in the output signal from the one or more local units.

18. The energy management system of claim 17, wherein the monitoring unit is configured to generate and output the time-varying, repeating signal with the one or more characteristics that include an amplitude of the time-varying, repeating signal.

19. The energy management system of claim 17, wherein the monitoring unit is configured to generate and output the time-varying, repeating signal with the one or more characteristics that include a frequency of the time-varying, repeating signal.

20. The energy management system of claim 17, wherein the monitoring unit includes an oscillator circuit configured to generate and output the time-varying, repeating signal as an oscillating signal.
